(19) United States
(12) Patent Application Publication
(10) Pub. No.: US 2015/0294304 A1
(43) Pub. Date: Oct. 15, 2015

(54) SECURE PAYMENT METHODS, SYSTEM, AND DEVICES

(71) Applicant: CELLCO PARTNERSHIP D/B/A VERIZON WIRELESS, BASKING RIDGE, NJ (US)

(72) Inventors: KEVIN DONNELLAN, NORTH BRUNSWICK, NJ (US); STEPHEN BARNA, CHATHAM, NJ (US)

(73) Assignee: CELLCO PARTNERSHIP D/B/A VERIZON WIRELESS, BASKING RIDGE, NJ (US)

(21) Appl. No.: 14/253,249

(22) Filed: Apr. 15, 2014

(51) Int. Cl. G06Q 20/38; G06Q 20/32

(52) U.S. Cl. CPC G06Q 20/382; G06Q 20/322

(57) ABSTRACT

Methods, systems, and devices for securely processing transactions using payment cards are disclosed. A transaction may be initiated using an identification value corresponding to a mobile device. The mobile device may then be contacted by remote servers to obtain payment card information. The mobile device may obtain the payment card information directly from a payment card that is present at the mobile device during the transaction.

### BACKGROUND

Payment cards, such as credit cards and debit cards, are linked to accounts and enable users to make purchases using those accounts. For example, a credit card enables a user to access a line of credit from their credit card account to make purchases and a debit card enables a user to access their bank account to make purchases.

Card not present transactions (CNP) are transactions made where the authorized user of the payment card (“cardholder”) is not physically present with the card at the time that the payment is made, e.g., online purchases made over the Internet. The unauthorized use of payment cards for CNP transactions is a major source of fraud. If a fraudulent CNP transaction is reported, the merchant acquiring bank hosting the merchant account that receives money from a fraudulent CNP transaction must make restitution. Therefore, card issuing banks typically charge a greater transaction rate for CNP transactions. For card present transactions (CP), the card issuing bank is liable for restitution.

Improved payment methods for keeping payment card information secure and for combating payment card fraud are needed.

### BRIEF DESCRIPTION OF THE DRAWINGS

Examples are best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. Included in the drawings are the following figures:

FIG. 1A is an illustration of a prior art payment system;

FIG. 1B is an illustration of a payment system in accordance with teachings described herein;

FIG. 1C is a block diagram of a payment system in accordance with teachings described herein;

FIG. 2A is a block diagram of a mobile device and a payment card for use with the system of FIG. 1C in accordance with teachings described herein;

FIG. 2B is a block diagram of a communication network in which the mobile device and payment card may be employed to make payments in accordance with teachings described herein;

FIG. 2C is an illustration of a payment transaction in accordance with teachings described herein;

FIG. 3 is a flowchart of steps for making payments with a mobile device in accordance with teachings described herein;

FIG. 4 is a flow chart of steps for obtaining payment information from a payment card for making payments in accordance with teachings described herein;

FIG. 5 is a block diagram of a mobile device illustrating data flow during a payment transaction in accordance with teachings described herein;

FIG. 6A is a block diagram of a payment system illustrating data flow during a payment transaction in accordance with teachings described herein;

FIG. 6B is a block diagram of a payment system illustrating another data flow during a payment transaction in accordance with teachings described herein;

FIG. 7 is a simplified functional block diagram of a computer that may be configured as a server; and

FIG. 8 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

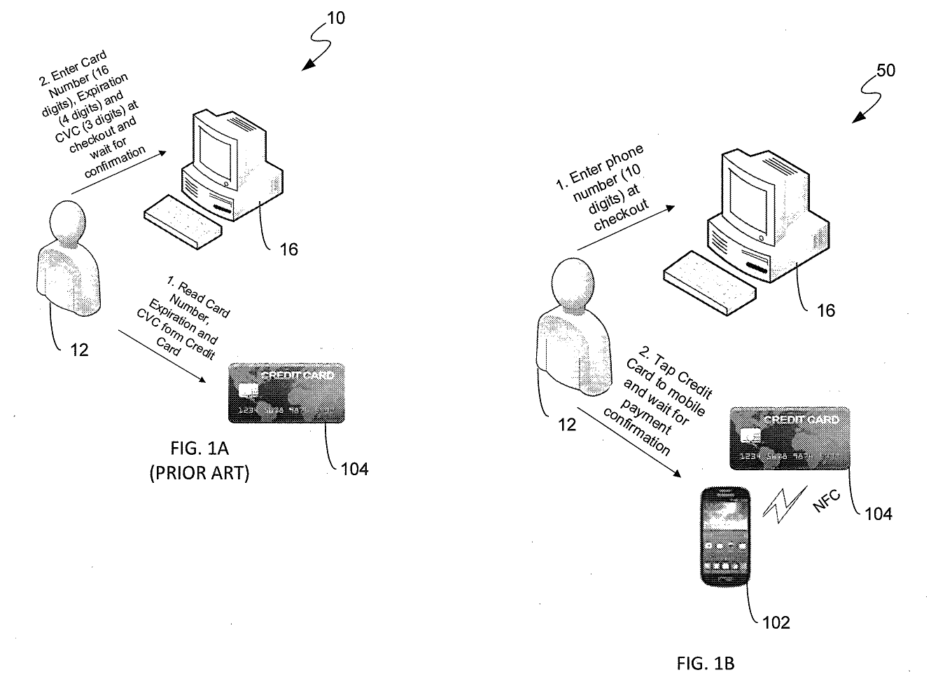

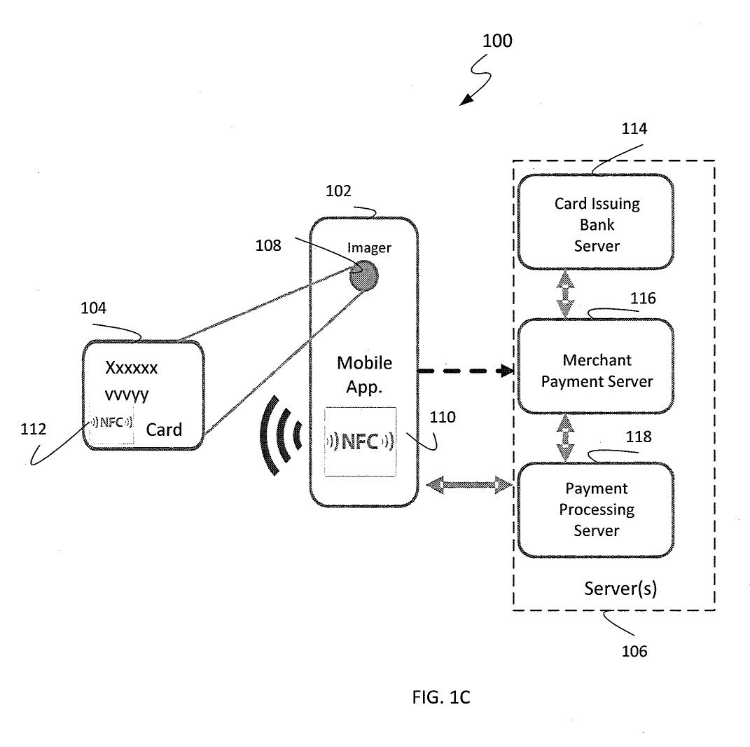

FIG. 1A depicts a payment solution 10 in accordance with the prior art. In accordance with payment solution 10, a consumer 12 making a payment with a payment card 104 for an “on-line” purchase from a merchant (not shown) typically reads the payment card information (e.g., credit card number, expiration date, and security code such as CVC) from the payment card and manually enters the read payment card information into the computer 16 they are using to make the on-line payment. The merchant receives the payment card information and supplies it to the merchant acquiring bank with which they are associated.

FIG. 1B depicts a payment solution 50 in accordance with teachings described herein. In accordance with payment solution 50, consumer 12 makes an on-line payment with a payment card 104 from their computer 16 using their mobile device 102. The consumer supplies the merchant with an identification value associated with their mobile device 102 (e.g., the telephone number of the mobile device or another value that maps to their mobile device) in lieu of supplying payment card information. The merchant supplies the identification value to their merchant acquiring bank or other processing entity, which identifies the mobile device 102 and prompts the consumer to present their payment card 104 for automated data capture of the payment card information by the mobile device 102. The payment card information is then securely transferred to the merchant acquiring bank (and ultimately the issuing bank) for approval of the payment transaction. Thus, the merchant is never in possession of payment card information and therefore does not have to be PCI compliant. In accordance with some teachings herein, the operating system (OS) of the mobile device 102 does not have access to the payment card information and the payment card information is not stored on any server (i.e., is PCI compliant). Thus, the payment card information remains secure. Additionally, where the telephone number of the mobile device 102 is used as the identification value, the customer only has to know their telephone number to initiate the payment transaction and the only information being provided is publicly available information.

FIG. 1C depicts a payment system 100 for making a payment with a payment card 104 in accordance with teachings described herein. The illustrated system 100 includes a mobile device 102, the payment card 104, and one or more remote servers 106. The illustrated servers 106 include a card issuing bank server 114 for a card issuing bank (e.g., EMV; Europay®, MasterCard® and Visa®), a merchant payment server 116 for a merchant acquiring bank, and a payment processing server 118. The mobile device 102 may communicate with the server(s) 106 via a network such as the Internet and/or a wireless network (not shown).

As used herein, the term “prospective purchase” refers to a purchase that a user is attempting to make. For example, the prospective purchase may be for items located in a user's virtual shopping cart at an on-line retailer such as Amazon.com®. In another example, the prospective purchase may be for an item an individual is attempting to buy from a physical retailer such as a stand at a farmers market.

As also used herein, the term “card present” refers to a payment transaction in which a payment card 104 is physically presented to the mobile device 102 when a transaction for a prospective purchase is being authorized by a card issuing bank/merchant acquiring bank. The term “card present” is also meant to cover payment transactions with payment cards that are not physically presented but are deemed “card present” payment solutions by a card issuing bank. Such payment transactions where the payment cards are not physically present but are deemed “card present” payment solutions by the card issuing bank are envisioned to include secure payment solutions where card payment information is securely stored within a mobile device, e.g., in an electronic wallet.

The mobile device 102 may be a mobile device 104 of a consumer attempting to make a prospective purchase in accordance with teachings described herein. In accordance with this teaching, the consumer may supply an identification value corresponding to their mobile phone when attempting to make a card present payment for their prospective purchase. In accordance with other teachings, the mobile device 102 may be a mobile device 104 of a merchant. In accordance with this teaching, the merchant may supply an identification value corresponding to their mobile phone when attempting to accept a payment for a prospective purchase by a consumer.

The mobile device 102 includes at least one automated data capture device, such as imager 108 and near field communication (NFC) module 110 in the illustrated embodiment, that enables card data from a payment card 104 to be automatically obtained by the mobile device 102 without the need for manual entry of data by a user. The NFC module 110 may be configured to communicate with NFC enabled payment cards in a manner similar to an NFC reader terminal. It is contemplated that one or more data capture devices may be utilized and that other data capture devices may be employed in addition to, or instead of, the ones depicted in the illustrated example.

The payment card 104 includes payment card information, including at least some information about or for an account associated with the card. The payment card information may be fully or partially printed on the front and/or back of the payment card 104. Alternatively, or additionally, the payment card information may be partially or fully stored electronically on the payment card 104 for access via an electromagnetic component such as a NFC module 112.

The payment processing server 118 may be a conventional server under the control of a wireless communication service carrier/provider, for example. The merchant payment server 116 may be a conventional server under the control of a merchant acquiring bank, and the card issuing bank server 114 may be a conventional server under control of a card issuing bank. It should be apparent from the description herein that the servers may be under the control of other entities and that the functionality of the servers may be performed by fewer (e.g., one or two servers) or more servers than the examples described herein. For example, the merchant payment server 116 may also function at the payment processing server 118. Also, any one of the servers may be implemented on a distributed basis via an appropriate number of network connected computers or the like, e.g. to handle an expected traffic load. A suitable server for one or more of the servers 106 may be a conventional server (e.g., a Tivoli Storage Manager (TSM) available from IBM Corporation of Armonk, New York, USA), for example.

Other suitable servers may be used to implement processing functions according to the description herein.

The mobile device 102 may be configured to capture payment card information from an image of the payment card 104 with the imager 108 and process the image to obtain payment card information from the payment card 104. In an alternative example, the mobile device 102 may capture electronic data from the payment card 104 with the NFC module 110 and process the electronic data to obtain the payment card information. In another alternative example, an image of payment card 104 may be captured along with electronic data and the captured data may be processed and combined to obtain the payment card information. The payment card information may include an account access number and a verification number such as a card verification value (CVV).

The payment card information may be captured using a single data capture device or multiple data capture devices of the mobile device 102. In accordance with a single data capture device teaching, all payment card information may be captured from the payment card 104 with the same device, e.g., NFC module 110 or imager 108. For example, the NFC module 110 may capture all payment card information (e.g., an account access number and a verification number) via an NFC communication with an NFC enabled payment card. Alternatively, the imager 108 may capture all payment card information (e.g., by obtaining an image of the front of the payment card and applying an optical character recognition algorithm to capture an account access number and by obtaining an image of the back of the payment card and applying an optical character recognition algorithm to capture a verification number). In accordance with a multiple data capture device teaching, a portion of the payment card information (e.g., an account access number) may be captured from the payment card 104 with the one device (e.g., the NFC module 110) and another portion of the payment card information (e.g., a verification number) may be captured with another device (e.g., imager 108).

In one use, where a consumer's mobile device 104 is used to make a prospective purchase in accordance with teachings described herein, the payment to a merchant for a prospective purchase may be performed without the prospective merchant having access to the payment card information. This is because the user provides the merchant with an identification value that corresponds to their mobile device (and not to their payment card account). As will be described in further detail below, the servers 106 then identify the mobile device 104 and contact the mobile device of the consumer for approval. If the consumer approves, the consumer presents their payment card and the payment card information is transferred to servers 106 for approval without passing to the merchant. Once approved, the servers 106 notify the merchant and the transaction is consummated. Increased security is provided because the merchant never has access to the actual payment card information and because the card is actually presented during the transaction.

In another use, where a merchant's mobile device 104 is used for a prospective purchase by a consumer in accordance with teachings described herein, a card present solution is provided (thereby reducing transaction costs). The merchant supplies an identification value that corresponds to their mobile device. As will be described in further detail below, the servers 106 then identify the mobile device 104 and contact the mobile device of the consumer for approval. If the consumer approves, the consumer presents their payment card to the merchant's mobile device and the payment card information is transferred to servers 106 for approval. Once approved, the servers 106 notify the merchant and the transaction is consummated. Increased security is provided because the card is actually presented during the transaction.

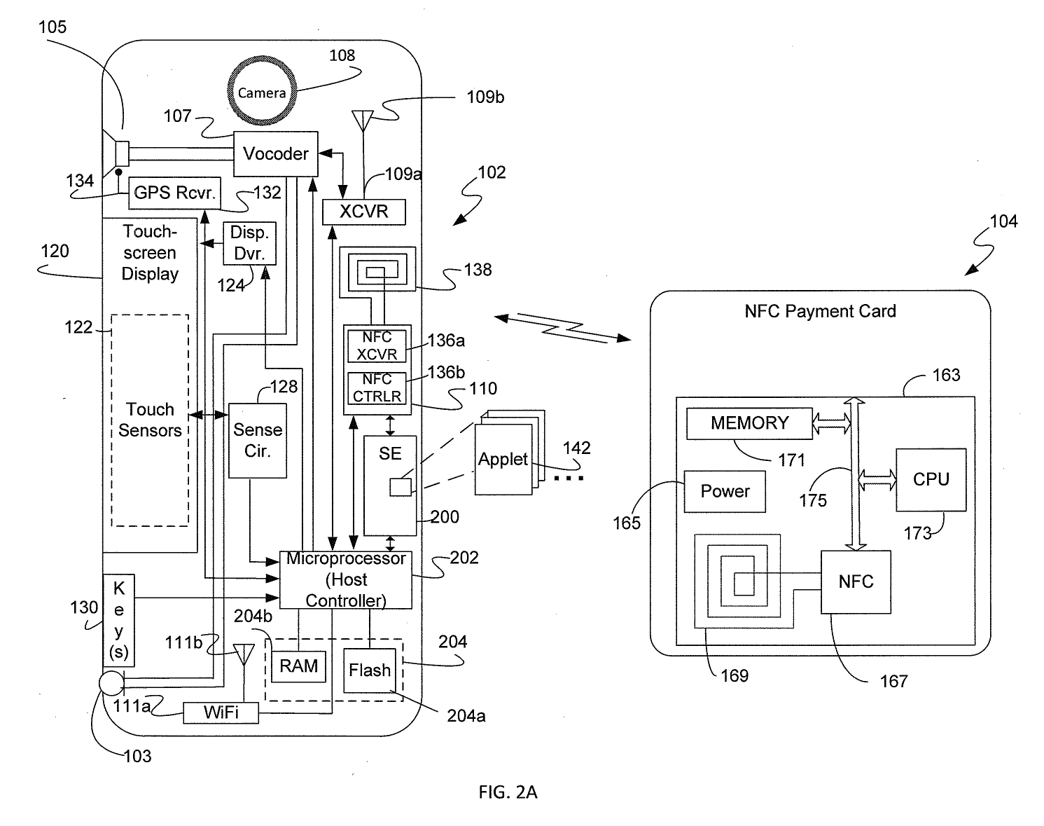

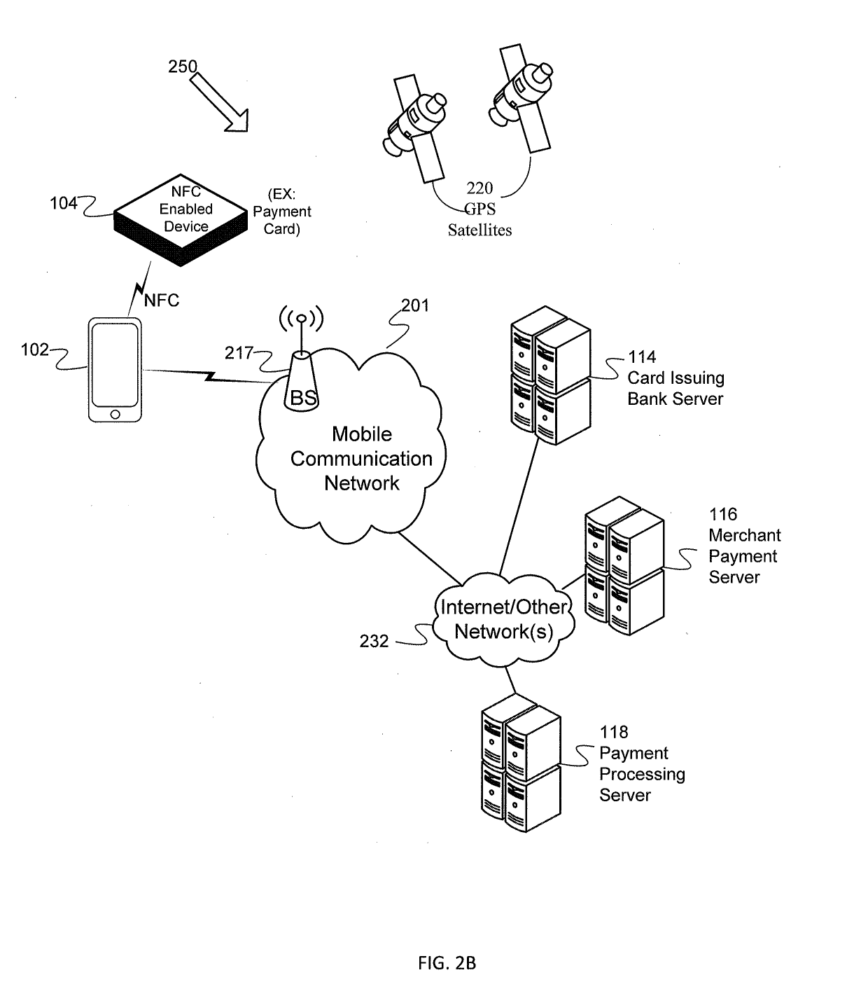

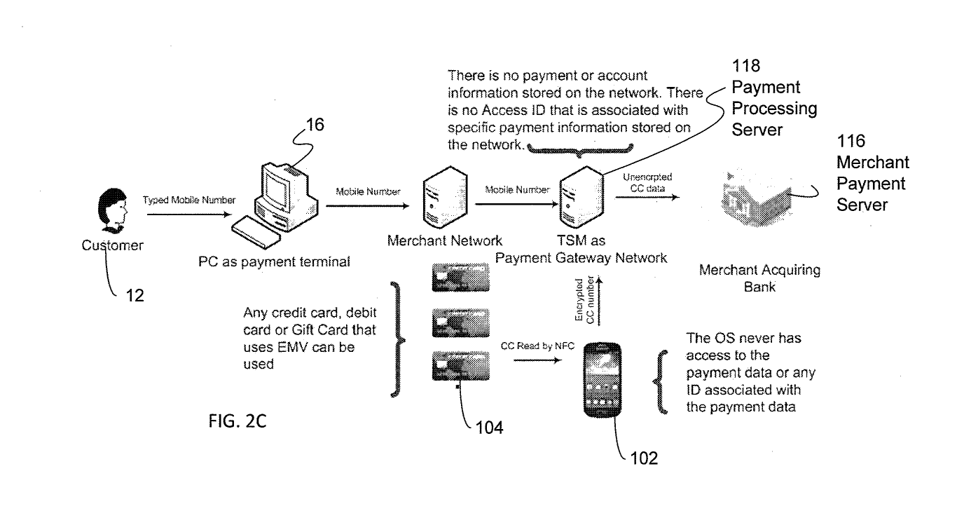

FIG. 2A depicts the mobile device 102 in additional detail and an NFC enabled payment card 104. In addition to the imager 108 and near field communication module 110 described above, the mobile device 102 in the illustrated example includes a secure component 200, a processor 202, and a memory 204. Memory 204 may include a flash memory 204a and a random access memory (RAM) 204b. The secure component 200 (e.g., a secure element or “SE”) may be provisioned on a subscriber identity module (SIM) or universal integrated circuit card (UICC) located within the mobile device 102 or may be provisioned within the memory 204. The processor 202 is coupled to the imager 108, the near field communication module 110, the secure component 200, and the memory 204. The processor 202 performs instructions which may be stored in memory 204 in order to retrieve payment card information from payment card 104, interface with servers 106, and route payment card information through the secure component 200. Additionally, the processor 202 may store data in memory 204 for later retrieval.

FIG. 2A additionally depicts a relatively short range wireless communication (NFC in the illustration) between the mobile device 102 and the payment card 104. The illustrated payment card 104 includes an NFC chipset. The NFC module 110 in the mobile device 102 communicates with the NFC enabled payment card 104, for example, to receive payment card information from the NFC enabled payment card 104. At a high level the user may brings the NFC enabled mobile device 102 within proximity (e.g., 2 to 4 cm or less, although in some cases the distance may be up to 20 cm) of the NFC enabled payment card 104. An application installed on the payment card 104 listens for NFC events and commences a contactless data flow by establishing communication with the NFC enabled mobile device 102.

The mobile device 102 may be configured in an NFC read mode. In the read mode, the mobile device 102 initiates communication with an NFC enabled payment card 104. In this mode, the mobile device 102 emulates a contactless card reader. For example, the mobile device 102 may communicate with an NFC enabled payment card 104 to access the payment card information. When a mobile device 102 is brought within range of the payment card 104, the NFC controller 136b on the mobile device 102 detects the presence of a contactless tag of the payment card 104 and generates a magnetic field, which may be used to power the contactless tag. Of course, the payment card 104 may also have its own power source 165. The NFC enabled payment card 104 responds with payment card information. The exchange may be controlled by the host controller 202.

The NFC controller 136b may be configured to implement a contactless frontend (CLF) for NFC communications. The CLF, for example, provides selective routing function based on whether or not a communication involves a security function. The NFC controller 136b of the mobile device 102 may determine whether a security function is required as described in further detail below. If a security function is not required, the NFC communication data is sent to the host controller 202 for processing. However, if a security function is required (e.g., for processing payment card information), the NFC communication data from the NFC enabled payment card 104 may be evaluated by a rule-set of the secure component 200. In one example, only if authentication criterion is met by the secure component 200 does the NFC controller 136b allow the host controller 202 to process the NFC communication data message provided by the NFC enabled payment card 104. The authentication criterion may include geographic and/or temporal limitations. Additional details on establishing and updating a rule-set is described below.

The NFC controller 136b may determine whether a security function is required in various ways. For example, if the NFC communication data from the NFC enabled device 104 includes payment card information, a security function may be required. In another example, even if the communication does not require a security function, a user of the mobile device can request the transaction to be secure (e.g., by selecting “secure transfer” on the display of the mobile device). The security requirement may be with respect to all NFC communication or more focused (e.g., all payment card information). Thus, a mobile device that is pre-configured to receive secure NFC communication, routes the NFC communication message received to the secure component 200 for processing (e.g., encryption). In another example, all NFC communication is routed to the secure component 200.

The rule-set is specific to the functionality of the secure component 200 and may be different from other rule-sets used for authentication and/or security that are unrelated to NFC transactions. The rule-set(s) may include geographic and/or temporal restrictions. Geographic restrictions may include limitations on where a mobile device must be located to retrieve payment card information. For example, payment card information can only be retrieved in the country where the registered user of the mobile device resides. Temporal restrictions may include limitations of the number of times payment card information may be retrieved within a specified period of time. For example, the mobile device may only retrieve payment card information a maximum of five times per 24 hour period.

The rule-set(s) may additionally, or alternatively, include purchase amount and/or purchase type restrictions. Purchase amount restrictions may include limitations on how many purchases may be made based on the cost of those purchases, e.g., 20 total purchases per week of any amount are allowed, but only 5 of those purchases may exceed $100. The purchase amount restrictions may additionally, be tied to the geographic location of the mobile device. For example, 10 purchases exceeding $100 may be made per week within a preferred use area (e.g., within 10 miles of a registered residence and/or registered office associated with the mobile device (e.g., based on zip code)) and only 2 purchases exceeding $100 may be made outside the preferred use area. Purchase type restrictions may include limitations on the type of purchases (e.g., business, clothing, groceries, etc.). For example, a business payment card may be set up to only enable purchases of under $250 at office supply stores or a person payment card may be set up to only enable purchases of groceries up to a total of $500 per week. Thus, the rule-sets may be configured to match the typical spending patterns of the user (e.g., by the user via an interface accessible via the Internet) in order to prevent unauthorized use.

The rule-set(s) may be preconfigured in the secure component 200 of the mobile device 102. One or more of the rule-set(s) may be updated by a user of a mobile device 102. A user may update the rule-set(s) via an input device such as a touch screen display 120 by selecting menu options presented by the mobile device 102 on the touch screen display 120. The use may select from two or more pre-configured options (e.g., low, medium, and high security). For example, a high security rule-set option will include authentication criteria having more conditions than a medium security option.

FIG. 2A illustrates elements of the mobile device 102 and elements of the NFC enabled payment card 104 in functional block diagram form, at a relatively high level. First, we will consider the mobile device 102.

It should be appreciated that the disclosed subject matter may be implemented using essentially any mobile computing apparatus having data capture capabilities, such as imaging and/or NFC communication capability. Although NFC data capture examples are described in detail, suitable modification for use with imaging and other data capture systems will be understood from the description herein.

In the example of FIG. 2A, the mobile device 102 is in the form of a smart phone type mobile handset including a touch screen display 120. Examples of touch screen type mobile devices that may be used to implement mobile device 102 may include (but are not limited to) a smart phone, personal digital assistant (PDA), tablet computer or other portable device with NFC capability. However, the structure and operation of the touch screen type mobile device 102 is provided by way of example; and the subject technology as described herein is not intended to be limited thereto. For purposes of this discussion, FIG. 2A provides a block diagram illustration of the exemplary mobile device 102 having a touch screen display for displaying content and receiving user input as (or as part of) the user interface.

Although the transactions that are the focus of discussions here utilize data communications, a typical mobile device such as the mobile device 104, also supports voice communications. Hence, in the example shown in FIG. 2A, the mobile device 102 includes a microphone 103 for audio signal input and a speaker 105 for audio signal output. The microphone 103 and speaker 105 are communicatively coupled to a voice or audio encoder/decoder (vocoder) 107. For a voice telephone call, for example, the vocoder 107 provides two-way conversion between analog audio signals representing speech or other audio and digital samples at a compressed bit rate compatible with the digital protocol of wireless telephone network communications or voice over packet (e.g., Internet Protocol) communications. The vocoder, speaker and microphone may also be used as elements of the user interface during other operations of the device, including some types of transaction communications.

Also, as shown in FIG. 2A, the mobile device 102 includes at least one digital transceiver (XCVR) 109a, for digital wireless communications via a wide area wireless mobile communication network, although the mobile device 102 may include additional digital or analog transceivers (not shown). The transceiver 109a conforms to one or more of the various digital wireless communication standards utilized by modern mobile networks. Examples of such transceivers include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and 3GPP Long Term Evolution (LTE), at times referred to as “4G.” For example, transceiver 109a provides two-way wireless communication of information including digitized audio signals, still image and/or video signals, web page information for display as well as web related inputs, and various types of mobile message communications to/from the mobile device 102.

Several of these types of communications through the transceiver 109a and a network, as discussed later, relate to using the secure component 200 (e.g., secure element (SE)) for securely transferring payment card information from a payment card to the servers 106. On-line transaction-related communications involving information obtained from the NFC enabled payment card 104, for example, may utilize Internet Protocol (IP) packet data transport utilizing the digital wireless transceiver (XCVR) 109a and over the air communications to and from servers 106. Such communications may include specific account related data and security information from the mobile device 102.

In one example, the transceiver 109a also sends and receives a variety of signaling messages in support of various voice and data services provided by a network of a wireless service provider, to a user of mobile device 102 via the mobile communication network. Transceiver 109a connects through radio frequency (RF) send-and-receive amplifiers (not shown) to an antenna 109b. Transceiver 109a may also support various types of mobile messaging services, such as short message service (SMS), enhanced messaging service (EMS), and/or multimedia messaging service (MMS). Although transaction communications involving account data typically utilize IP data transport, such transaction communications may at times utilize one or more of these mobile messaging services for the data transport through the mobile communication network.

Many modern mobile devices also support wireless local area network communications over WiFi, instead of or in addition to data communications using the wide area mobile communication network. Hence, in the example of FIG. 2A, for packet data communications, the exemplary mobile device 102 may also include a WiFi transceiver 111a and associated antenna 111b. Although WiFi is used here as the example, the transceiver 111a may take the form of any available two-way wireless local area network transceiver of a type that is compatible with one or more standard protocols of communication implemented in wireless local area networks, such as one of the WiFi standards under IEEE 802.11 and/or WiMAX. The transceiver 111a, for example, may provide two-way data transport for wireless communication with a wireless access point in a residence or enterprise, that the user frequents or with any available hotspot offered in a public venue. Although communicating through a different network or networks, the transceiver 111a supports various types of data communications similar to the packet data communications supported via the mobile network transceiver 109a, including communications related to payment card information obtained from the NFC enabled payment card 104 passing through the secure component 200 (e.g., an SE).

The mobile device 102 further includes a microprocessor, sometimes referred to herein as the host controller 202, which serves as a programmable controller for mobile device 102 by configuring mobile device 102 to perform various operations, for example, in accordance with instructions or programming executable by processor 202. For example, such operations may include various general operations of the mobile device 102 as well as operations related to the communication with the NFC enabled payment card 104 and conducting related transactions as described herein. A flash memory 204a is used to store, for example, programming or instructions for execution by the processor 202. Depending on the type of device, the mobile device 102 stores and runs an operating system through which specific applications may be run on the device. Examples of operating systems include Android, Apple iOS (I-Phone or iPad devices), Windows Mobile, RIM BlackBerry operating system, or the like. Flash memory 204a may also be used to store mobile configuration settings for different mobile applications or services executable at mobile device 102 (using processor 202). Mobile device 102 may also include a non-volatile random access memory (RAM) 204b for a working data processing memory.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules. The instructions or programming may be used to implement the interaction with the NFC enabled payment card 104 and related transactions, as described herein. Program aspects of the technology may be thought of as “products” or “articles of manufacture” typically in the form of executable code or process instructions and/or associated data that is stored on or embodied in a type of machine or processor readable medium.

A mobile device supporting payment transactions of the type under consideration here may include a variety of different types of user interface elements. For discussion purposes, in the mobile device 104 shown in FIG. 2A, the user interface elements of mobile device 102 include a touch screen display 120 (also referred to herein as “touch screen 120” or “display 120”). For output purposes, the touch screen 120 includes a display screen, such as a liquid crystal display (LCD) or the like. For input purposes, touch screen display 120 includes a plurality of touch sensors 122. Touch sensors 122 may be configured as a biometric sensor that captures a biometric signature, e.g., a finger print. Other interface elements may include an imager 108 and a keypad including one or more keys 130. Imager 108 may also be configured as a biometric sensor that captures a biometric signature, e.g., an image of a retina. The keypad may be implemented in hardware as a T9 or QWERTY keyboard of mobile device 102 and keys 130 may correspond to the physical keys of such a keyboard. Alternatively, keys 130 (and keyboard) of mobile device 102 may be implemented as “soft keys” of a virtual keyboard graphically represented in an appropriate arrangement via touch screen display 120. The soft keys presented on the touch screen display 120 may allow the user of mobile device 102 to invoke the same user interface functions as with the physical hardware keys. In some implementations, the microphone 103 and speaker 105 may be used as additional user interface elements, for audio input and output, including with respect to some functions related to the transaction processing and communication, as described herein.

For output, touch screen display 120 may be used to present visible information (e.g., text, video, graphics or other visible content) to the user of mobile device 102. Host controller 202 controls visible display output on the LCD or other display element of the touch screen display 120 via a display driver 124, to present the various visible outputs to the device user. For example, some of the transaction-related programming may cause the processor 202 to operate the driver 124 to cause screen 120 to display visible multimedia information corresponding to steps performed by the mobile device 102 to perform card present payments as described herein.

In general, touch screen display 120 and touch sensors 122 (and one or more keys 130, if included) are used to provide the textual and graphical user interface for the mobile device 102. In an example, touch screen display 120 provides viewable content to the user at mobile device 102. Touch screen display 120 also enables the user to interact directly with the viewable content provided in the content display area, typically by touching the surface of the screen with a finger or an implement such as a stylus.

As shown in FIG. 2A, the mobile device 102 also includes a sense circuit 128 coupled to touch sensors 122 for detecting the occurrence and relative location/position of each touch with respect to a content display area of touch screen display 120. In this example, sense circuit 128 is configured to provide processor 202 with touch-position information based on user input received via touch sensors 122. In some implementations, processor 202 is configured to correlate the touch position information to specific content being displayed within the content display area on touch screen display 120. The touch-position information captured by sense circuit 128 and provided to processor 202 may include, but is not limited to, coordinates identifying the location of each detected touch with respect to the display area of touch screen display 120 and a timestamp corresponding to each detected touch position.

The user interface capabilities of the mobile device 102 provide output to and receive input from the user of the mobile device 102, for any of the various functions, operations or applications of the device. For example, programming (discussed more later) that configures the mobile device 102 to obtain and act on data from the NFC enabled payment card 104 may include further acknowledgment requests from the user. For example, the mobile device 102 may present information on the display 120 about a prospective purchase and query the user for approval to proceed with obtaining payment card information prior to reading payment card information from the NFC enabled payment card 104.

Many implementations of mobile devices today support location based services. Location information may be used in a variety of services/applications. Some uses or transactions involving payment card information obtained from the NFC enabled payment card 104 may also involve location determination. For example, the location information of the mobile device 102 may be part of the information provided to a server (e.g., payment processing server discussed later) to determine the authenticity of the transaction. By way of just one example, the current location of the mobile device 102 may be recorded in memory of the device and/or communicated to a server or other equipment involved in a transaction, when the mobile device communicates over a network (e.g. to conduct a transaction). If the mobile device is in a restricted area (e.g., in a foreign country) transactions may be prohibited.

There are a variety of ways that a mobile device 102 may be configured to obtain information as to current location of the device. In one example, the mobile device 102 includes a global positioning satellite (GPS) receiver 132 and associated antenna 134. GPS is a space-based satellite navigation system that provides location and time information anywhere on Earth, where there is an unobstructed line of sight to at least three, or more of the GPS satellites.

As described above, the illustrated mobile device 102 has NFC communication capability. NFC may be used for a variety of different functions or applications of the mobile device 102. In one example, the mobile device 102 interacts with the NFC enabled payment card 104 via the NFC communication capability of the mobile device 102 to retrieve payment card information. NFC is a set of standards for smart phones and similar devices, such as the exemplary mobile device 102 discussed here, to establish radio communication with other such devices as well as with compatible NFC readers by coming to close proximity (e.g., 4-10 cm or less). Due to its short range and support for encryption, NFC communication is suitable for secure communication over short distances. Each NFC enabled mobile device includes a transceiver configured to communicate with other NFC capable equipment.

The illustrated mobile device 102 further includes an NFC sensor. The NFC sensor may be implemented in a variety of ways. In the exemplary mobile device 102 of FIG. 2, the NFC sensor includes an NFC type radio frequency transceiver 136a, which is formed by an NFC chipset 110. The NFC chipset 110 provides two-way wireless communication of information in accordance with NFC technology and protocols. The NFC chipset 110 includes an NFC controller 136b. For simplicity, the NFC 110 is sometimes referred to herein as the NFC controller or module 110, while it will be understood that it is a controller within the NFC chipset 136. The exemplary NFC sensor also includes an antenna, such as coil antenna 138. The NFC chipset 110 of apparatus 102 connects to the NFC coil antenna 138, for transmitting and receiving NFC communications to/from other NFC compatible devices with compatible transceivers over short air link distances. The transceiver 136a formed by the NFC chipset 110 also sends and receives a variety of signaling messages for establishing NFC links with other NFC-enabled devices and sends and receives various user data over the established NFC links. The signaling, for example, may allow the transceiver formed by the NFC chipset 110 to detect proximity of another NFC capable device, establish an NFC link with the other device, trigger execution of an appropriate application within the mobile device 102 and send and/or receive data for the application as between the mobile device 102 and the other NFC capable device. Some modern mobile devices are already equipped with such NFC equipment, and increased NFC deployment is expected in the future.

In order to run secure applications such as payment applications the secure component may be implemented as a separate chip that includes tamperproof storage and execution memory and is configured to communicate with an NFC controller 136b (a secure processor). The NFC controller 136b is different from the host controller 202 in that it focuses on enabling secure transactions. The secure component contains applications (e.g., applets) that use secure keys running inside the secure processor. For example, there may be at least one applet 142 for processing of a payment transaction and encrypting payment card information received from the payment card 104.

The applications that run on the secure component may run on a Javacard operating system. The secure component may include various account information, such as account number, user identification, a personal identification number (PIN), or the like for user verification and possibly account balance and/or transaction record information. The secure component may be used to decode credentials of NFC enabled devices. In various examples, the secure component may be part of a subscriber identification module (SIM), universal integrated circuit card (UICC), or a separate secure element like a secure digital (SD) memory card used for storing and accessing applications and data in a secure manner.

Although cryptographic elements are not separately shown, the NFC chip 110 may be configured such that NFC transmissions can be encrypted. In one example, communications between the secure component and the servers 106 may be encrypted. Accordingly, the secure data storage and encrypted communication provide enhanced security and reduce the likelihood of fraud against a user's payment transactions.

In one example, the NFC controller 110 is configured to route all NFC traffic (e.g., data message from or sent to an NFC enabled device) through a secure component 200. Thus, the NFC controller 110 may route NFC communication between the NFC system and the secure component 200 without going to or from the host controller 202.

It will be understood that not all applications require the use of a security function. For example, two mobile device users may want to exchange business cards. To this end, the NFC controller 110 may have the ability to send the information directly to the host controller 202 for further execution (without the security function of the secure component 200). Accordingly, in one example, the NFC controller 110 is configured to determine whether a security function is required. If so, the NFC controller 110 routes the near field communication between the NFC system and the secure component 200 without going to or from the host controller 202. However, upon determining that a security function is not required, the NFC communication may be routed between the NFC system and the host controller 202 without going to or from the secure component 200.

The NFC controller 110 may determine whether a security function is required in various ways. For example, if payment card information is being read from a payment card, a security function may be used to keep the payment card information secure. Also, if data from the NFC enabled payment card 104 includes a key, a security function may also be used. In another example, even if the communication may not require a security function (e.g., a simple transfer of a photo between two NFC enabled mobile devices) the user of the transferor or transferee (i.e., writing or reading) mobile device may request the transaction to be secure. For example, the user of a mobile device can pre-configure their mobile device by selecting an option (e.g., on the user display) that requires information that is received and/or transferred to another mobile device to be secure. The security requirement may be with respect to all NFC communication or more focused (e.g., all mobile devices that are not on a “close friends” or “authorized” list stored in the mobile device). Thus, a mobile device that is pre-configured to receive secure NFC communication, routes the data message received to the secure component for evaluation. If a security key is not included in the data message, then the message may be deemed not secure.

In another example, all NFC communication is routed to the secure component. Consequently, the host controller is prevented from executing any instructions in the data message. In one example, the display of the mobile device indicates when a data message could not be authenticated and provides an option to override the security feature. Thus, the user of the mobile device may be able to override the security feature and select to have the data processed even if the secure component cannot authenticate the security of the data message. In accordance with one teaching, the user of the mobile device is able to override the security feature regardless of source (e.g., merchant, personal contact, etc.) and content (e.g., monetary, non-monetary, etc.). In accordance with other teachings, the user of the mobile device is able to override the security feature only for predefined types of messages (e.g., non-monetary) and/or predefined sources (e.g., merchants on an approved list).

The logic implemented by the host controller 202 of the mobile device 102 configures the processor 202 to control various functions as implemented by the mobile device 102. The logic for a processor may be implemented in a variety of ways, e.g., through programming for execution by the microprocessor 202. Similarly, logic implemented by the NFC controller 136b configures the controller 110 to control various functions related to NFC communication. For example, one or more application programs are stored in the secure component 200 for execution by the NFC controller 136b. Any application that is intended to utilize payment card information obtained from the NFC enabled payment card 104 may include information stored in the secure component 200. For example, information in connection with a transaction with an NFC enabled payment card 104 is stored in the secure component 200, which when executed by the microprocessor 202 enables the mobile device 102 to the servers.

The structure and operation of the mobile device 102, as outlined above, were described by way of example only.

The NFC enabled payment card 104 in our example includes a power supply module 165, an NFC transceiver 167 and associated coil antenna 169, and one or more memories 171. The NFC enabled payment card 104 may or may not include a processor serving as the central processing unit (CPU) 173 of the chip 163 and a bus system 175. For example, a CPU may not be included if the NFC enabled payment card 104 is used as a tag but otherwise may be included if used in a P2P transaction or a smartcard transaction. The NFC enabled payment card 104 may or may not include a battery or other internal power source. For example, instead of a power source, the power module 165 may collect energy at the time of a communication from the RF transmissions from the mobile device 102 via inductive coupling. Power may be obtained via the coil antenna 169 or another inductive coil (not separately shown) in or connected to the chip 163. The power module 165 converts the collected energy to one or more appropriate direct current (DC) voltage levels and distributes the resulting DC power to the other elements on the chip 163, as needed.

The exemplary NFC transceiver 167 connects to the coil antenna 169, for transmitting and receiving RF communications to/from the NFC enabled mobile device 102. Hence, the chipset 136 and NFC transceiver 167 are sufficiently compatible to enable the mobile device 102 to detect and communicate with an NFC enabled payment card 104. In one example, from the perspective of the card, the NFC enabled mobile device 102 can appear as a reader NFC enabled device. Thus, the NFC enabled payment card 104 may act as a tag and the mobile device 102 may act as a reader when in read/write mode of operation.

The memory 171 of the NFC enabled payment card 104 stores data and/or executable programming for the CPU 173. In one example, the memory 171 may include a key that is used for security purposes by the secure component 200 of the mobile device 102. For example, this key may be provided by a prior provisioning process. Thus, the payload provided by the NFC enabled payment card 104 to the mobile device 102 may include digital payload (e.g., account number) and a key. The NFC controller 136b of the mobile device, upon determining that a security feature is required, sends the payload to the secure component 200 for authentication. Upon authentication, the NFC controller may route the payload (e.g., without the key) to the host controller 202 for processing.

The bus 175 supports signaling and transfer of data and/or instructions as between various elements on the chip 163 including the CPU 173, the memory 171 and the NFC transceiver 167. The memory 171 and programming execution by the CPU 173 provide data storage.

The structure and operation of the NFC enabled payment card 104, as outlined above, were described by way of example, only.

FIG. 2B illustrates a system 250 offering a communication framework for processing payment transactions. The example of FIG. 2B shows a mobile device 104 that may communicate with a payment card 104 (e.g., through NFC communication) when the mobile device is in close proximity to the payment card. During processing of payment transactions, the mobile device 104 may have access to the mobile communication network 201.

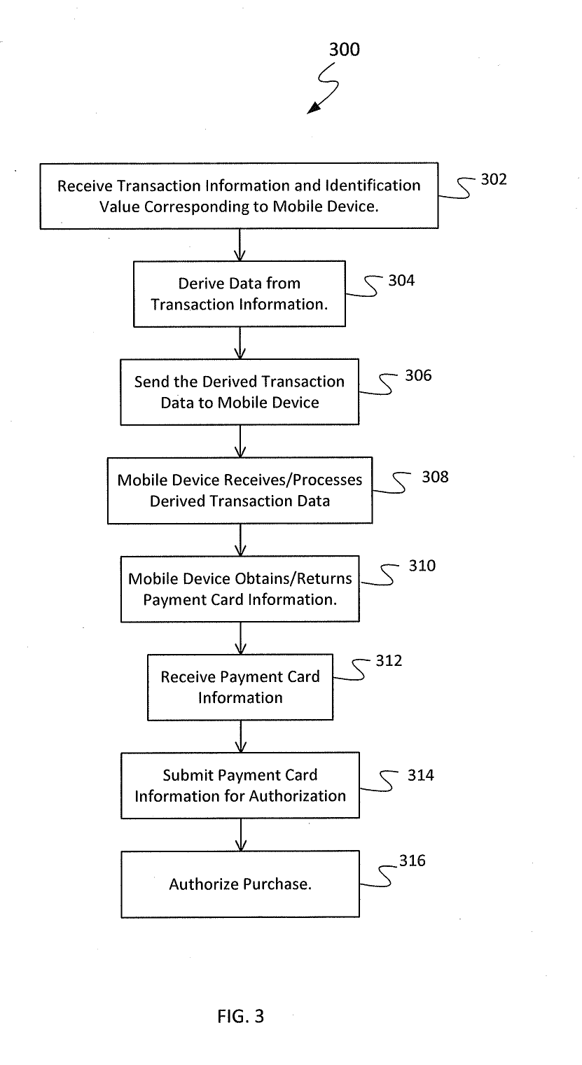

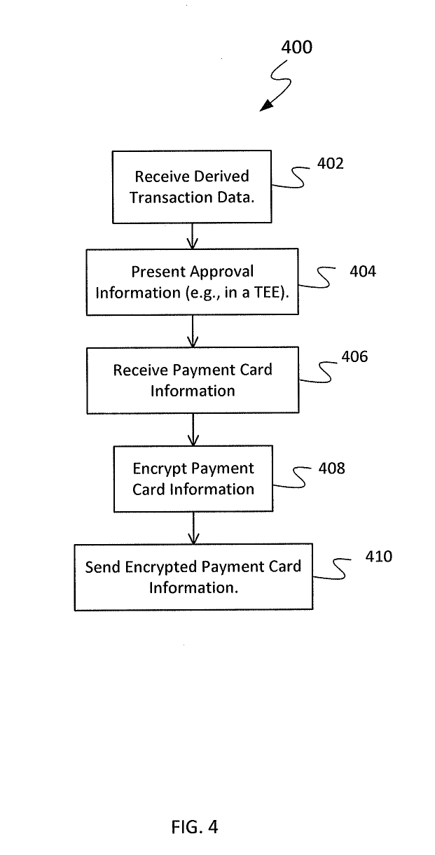

Mobile device 104 may be configured to act as a card reader in interactions with payment card 204 in order to obtain payment card information. As described in detail below with reference to FIGS. 3 and 4, the mobile device 102 receives payment card information from the payment card 104.

In the example of FIG. 2B, the mobile communication network 201 provides communications for mobile device 104 for payment card services as well as for mobile devices/users that do not participate in payment card services. Thus, network 201 may provide regular voice and data cellular services. The network 201 provides wireless communications services to the mobile device shown and other mobile device (not shown), via a number of base stations (BSs) 217. The present techniques may be implemented in any of a variety of available mobile networks 201 and/or on any type of mobile device compatible with such a network 201, and the drawing shows only a very simplified example of a few relevant elements of the network 201 for purposes of discussion here.

The mobile communication network 201 may be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard, the Long Term Evolution (LTE) standard, or other standards used for public mobile wireless communications. In one example, the mobile device 104 is capable of voice telephone communications through the network 201, receiving transaction information from servers 106, and sending payment card information to servers 106. The mobile device 104 is capable of data communications through the particular type of network 201, and the users thereof typically will have subscribed to data service through the network.

The mobile communication network 201 can be implemented by a number of interconnected networks. Hence, the overall network 201 may include a number of radio access networks (RANs), as well as regional ground networks interconnecting a number of RANs and a wide area network (WAN) interconnecting the regional ground networks to core network elements. A regional portion of the network 201, such as that serving mobile device 102, can include one or more RANs and a regional circuit and/or packet switched network and associated signaling network facilities.

Physical elements of a RAN operated by one of the mobile service providers or carriers include a number of base stations represented in the example by the base stations (BSs) 217. Although not separately shown, a base station 217 can include a base transceiver system (BTS), which can communicate via an antennae system at the site of base station 217 and over the airlink with one or more of the mobile devices, when the mobile device 102 within range. Each base station 217 can include a BTS coupled to several antennae mounted on a radio tower within a coverage area often referred to as a “cell.” The BTS is the part of the radio network that sends and receives RF signals to/from the mobile device 102 that are served by the base station 217. The network can also include other elements that support functionality other than device-to-device media transfer services such as messaging service messages and voice communications. Specific elements of the mobile communication network 201 for carrying the voice and data traffic, and for controlling various aspects of the calls or sessions through the network 201, are omitted here for simplicity. It will be understood that the various network elements can communicate with each other, as well as other aspects of the mobile communication network 201, and other networks (e.g., the public switched telephone network (PSTN) and the Internet 223) either directly or indirectly.

The carrier providing communication and other services through the network 201 may also operate a number of systems that provide ancillary functions in support of the communications services and/or application services provided through the mobile communication network 201; and those elements communicate with other nodes or elements of the mobile communication network 201, such as one or more private IP type packet data networks 232 (sometimes referred to as an Intranet), i.e., a private network. Generally, such ancillary systems are part of or connected for communication via the private network 232 of the establishment discussed herein. It will be understood that systems outside of the private network could serve the same functions as well. Examples of such systems, in this case operated by the network service provider as part of the overall system 250, which communicate through the intranet type network 232, include one or more servers.

Card issuing bank server 114 is configured to provide various functions, including the function of authorizing transactions for prospective purchases based on card payment information received by a mobile device 102, e.g., via the merchant payment server 116 and/or payment processing server 118.

Merchant payment server 116 is configured to provide various functions. In accordance with one teaching, the MPS 116 is configured to receive transaction information for prospective purchases and payment card information from the payment processing server 118, interface with the card issuing bank server 114 to receive authorization of the payment card information for the prospective purchase, and notify the payment management server 118 of the authorization. In accordance with other teachings, the merchant payment processor 116 may receive transaction information and an identifier corresponding to a mobile device 102 directly from a merchant, interface with the payment processing server 118 to retrieve payment card information for the prospective purchase, interface with the card issuing bank server 114 to receive authorization of the payment card information for the prospective purchase, and notify the payment management server 118 of the authorization.

Payment processing server 118 is configured to provide various functions. In accordance with one teaching, the payment processing server 118 is configured to receive transaction information and an identifier corresponding to a mobile device 102 from a merchant, interface with the mobile device 102 to retrieve payment card information for the prospective purchase, interface with the merchant payment processor 116 to receive authorization of the payment card information for the prospective purchase, and notify the mobile device 102 of the authorization. In accordance with other teachings, the payment processor server 116 may receive transaction information and an identifier corresponding to a mobile device 102 from the merchant payment server 116, interface with the mobile device 102 to retrieve payment card information for the prospective purchase, interface with the merchant payment server 116 to receive authorization of the payment card information for the prospective purchase, and notify the mobile device 102 of the authorization.

While in the example of FIG. 2B the card issuing bank server 114, the merchant payment server 116, and the payment processing server 118 have been illustrated as separate servers, the functionality described herein with respect to each of the servers 114, 116, and 118 can also be provided by one or multiple different computing devices. In other words, the card issuing bank server 114, the merchant payment server 116, and the payment processing server 118 need not be stand-alone computing devices but can be combined in various configurations with each other and/or with other server functions.

In one example, the system 250 includes a plurality of satellites 220 to provide location information to a mobile device 102 where there is an unobstructed line of sight between the satellites 220 and the receiver of the mobile device 102. For example, the mobile device 102 may use its GPS receiver 134 to determine its location information. For an additional level of security, the location information may be associated with payment card information received from the payment card 104 in the secure component of the mobile device 102. In this example, the secure component may include the location information in determining whether to process the payment card information. The secure component may have stored in its memory location information for the mobile device 102. Accordingly, if the mobile device 102 is not within a predetermined radius of the stored location information, the payment card information may not be provided. The structure and operation of system 250, as outlined above, were described by way of example only.

FIG. 2C provides a process flow overview between the consumer 16, the mobile device 102, the merchant network, the payment processing server 118, and the merchant acquiring bank server 116. Three variations are described below with respect to FIG. 2C. These three variations include: (1) payment from the computer directed by the merchant acquiring bank, (2) payment from the computer directed by the payment processor, and (3) payment from the mobile device browser directed by the merchant acquiring bank. These variations are described in further detail below along with further variations with reference to FIGS. 3, 4, 5, 6A, and 6B.

In accordance with the first variation, the merchant sends transaction information and an identification value corresponding to at least one mobile device 102 (e.g., mobile device number; MDN) to the server 116 of the merchant acquiring bank directly. In accordance with one teaching, the identification value is the telephone number associated with the mobile device 102. As described in further detail below, where the identification value is the telephone number associated with the mobile device 102 (which is easy for the user of the mobile device to remember), a payment processing server with access to account information associated with the mobile device, can determine the mobile device from its associated telephone number. In accordance with other teachings, the identification value is a value also associated with the mobile device 102, but the value is not the telephone number associated with that mobile device (referred to herein as a non-telephone number identification value). As described in further detail below, where the identification value is a non-telephone number identification value associated with the mobile device 102, a payment processing server with access to information that associates non-telephone number identification values with mobile devices (e.g., a look-up table), can determine the mobile device from its associated non-telephone number identification value. The non-telephone number identification value may be associated with one mobile device 102 or multiple mobile devices 102. Where the non-telephone number identification value is associated with multiple mobile devices, and as described in further detail below, each of the mobile devices are contacted during a payment transaction.

The merchant acquiring bank then forwards the identification value and the transaction information to the payment processing server 118 (e.g., a trusted service manager (TSM)/mobile key management server), which contacts the mobile device(s) 102 it serves with that identification value. The mobile device 102 then captures payment card information from the payment card. Once the mobile device 102 receives the payment card information the mobile device 102 forwards the payment card information to the payment processing server 118, which decrypts the payment card information and sends the decrypted payment card information to the merchant acquiring bank server 116. The merchant acquiring bank then clears the transaction with the card issuing bank and ultimately informs the payment processing server 118, the mobile device 102 and the merchant of the result of the transaction clearance. The result may be a communication indicating that the payment transaction was authorized if the transaction was cleared or was declined if the payment transaction was not cleared. The result to each of the payment processing server 118, the mobile device 102, and the merchant may be the same or may be different. In accordance with teachings where the communications are different, a first communication may be sent to one entity (e.g., the payment processing server 118) providing brief information (e.g., the transaction number and an indication of whether the transaction was authorized or declined) and a second communication providing more explanation may be sent to the mobile device 102 (e.g., “Congratulations! Your purchase of a pair of pants from merchant X has been approved.” or “We regret to inform you that your purchase of perfume from merchant Y has been declined.”). In accordance with teachings described herein, the merchant acquiring band server 116 or the payment processing server 118 may tailor the result provided to each recipient. An advantage of this solution is that the merchant, the browser, and the associated PC on which the browser is running never have access to the payment card information regardless of whether it is encrypted or not.

In accordance with the second variation, the merchant sends the transaction information and the identification value corresponding to a mobile device 102 (e.g., mobile device number; MDN) to the payment processing server 118 (e.g., a trusted service manager (TSM)/mobile key management server). The payment processing server 118 then communicates with the appropriate mobile device 102 to receive the payment card information, which supplies the payment card information in encrypted form. The payment processing server 118 decrypts the payment card information and sends the payment card information to the merchant acquiring bank server 116. The merchant acquiring bank then clears the transaction with the card issuing bank and forwards the result of the transaction clearance back to the payment processing server 118. The payment processing server 118 relays the result to the mobile device 102 and the merchant. As described above, the result provided to each of the payment processing server 118, the mobile device 102, and the merchant may be the same or may be different. In accordance with one teaching, the payment processing server 118 may tailor the result provided to each recipient. In this solution the payment processing server 118 may act in a similar manner to a conventional payment gateway with an exception being that the payment card information does not initiate from the merchant, it instead comes from the mobile device.

The third variation is a variation on the first or second variation. In accordance with the third variation, the customer 12 may use a browser on the mobile device 102 itself rather than a separate computer 16.

FIG. 3 depicts a flow chart 300 of steps for securely processing a payment in accordance with teachings described herein. The steps for payment processing are described with reference to the payment card 104, mobile device 102, and remote system 106 described above with reference to FIGS. 1 and 2A. It will be understood that other cards, apparatus, and systems may be employed to implement the steps described below.

At step 302, transaction information for a prospective purchase and an identification value corresponding to a mobile device 102 are received. The transaction information and the identification value may be received by a payment processing server 118. The payment processing server 118 may be a stand-alone service provider server maintained by a wireless communication provider or may be incorporated into a merchant payment server 116. The identification value may be essentially any sequence of numbers, letters, or symbols that can be used to identify a mobile device, including a mobile telephone number of the mobile device. In accordance with teachings described herein, multiple identification values may be associated with a mobile device 102. The identification values may be associated with different transactions (e.g., type, amount, location, person making the transaction). For example, a first identification value (e.g., the telephone number associated with the mobile device) may be used for purchases that cost less than $10 and a second identification value (e.g., a non-telephone number identification value associated with the mobile device) may be required for purchases greater than $10. In another example, a first identification value may be used for business purchases and a second identification value may be used for home purchases. The identification value may be recorded along with the payment transaction information to enable tracking of business and home expenses, for example. In another example, a first identification value having restricted use may be used by family members of a primary account holder associated with a payment card and a second, less restrictive, identification value may be used by the primary account holder.

In accordance with teachings described herein, the prospective purchase may originate from a session between the mobile device 102 of a consumer/user and a merchant's website. In accordance with other teachings described herein, the prospective purchase may originate from a session between a computing device other than the mobile device 102 of the consumer (e.g., a browser on the consumer's home PC or laptop) and a merchant's website.

Where prospective purchases originate from a session with a merchant's website, consumers/users may place items for prospective purchase in a virtual shopping cart. Upon checkout, the merchant website may solicit payment information from the user. In lieu of submitting traditional payment information such as a payment card number associated with a payment card 104, the user/consumer submits an identification value corresponding to the user's mobile device 102. The merchant website then transmits transaction information for the prospective purchase along with the identification value corresponding to the mobile device 102 to the payment processing server 118, where both pieces of information are received.

In accordance with still other teachings described herein, the prospective purchase may originate from a mobile device 102 of the merchant/user. Where prospective purchases originate from the merchant's mobile device 102, the merchant may identify items for prospective purchase on their mobile device. The merchant may then supply an identification value corresponding to their mobile device 102 or the identification value (which may be the mobile device telephone number) may be automatically supplied by the mobile device 102. The mobile device 102 then transmits transaction information for the prospective purchase along with the identification value corresponding to the mobile device 102 to the payment processing server 118, where both pieces of information are received.

The payment processing server 118 may be configured for communication with a merchant payment server 116 and configured for communication with the mobile device 102. The merchant payment server 116 may further be configured for communication with a card issuing bank server 114. The payment processing server 118 may receive the transaction information and the identification value corresponding to the mobile device 102 directly from a merchant (e.g., Amazon.com) or a mobile device of the merchant. The payment processing server 118 alternatively may receive the transaction information and the identification value corresponding to the mobile device 102 indirectly from the merchant (e.g., via the merchant payment server 116 of the merchant acquiring bank associated with the merchant).

At step 304, data is derived from the received transaction information and the mobile device is identified. The data may be derived by the payment processing server 118. The payment processing server may include a processor and memory (not shown). The processor may be configured to perform the derivation of data from the transaction information. The transaction information may include the identification value and transaction details, e.g., amount, type of goods, merchant, etc. The processor may be configured to derive transaction data from the transaction details. The derived transaction data is a representation of the received transaction information that is sufficient to notify the user of the prospective purchase. The derived transaction data may be the received transaction information, a subset thereof (e.g., a version redacted by the processor to include only transaction data necessary for the mobile device to notify the user of the mobile device of the prospective purchase), and/or a modified version of the transaction data based on the received transaction information (e.g., a version reformatted by the processor for communication to the mobile device or another server. If the identification value is a mobile telephone number of the user's mobile device, the payment processing server 118 may identify the mobile device directly using the mobile telephone number. If the identification value is a value other than the mobile telephone number of the user's mobile device, the payment processing server 118 may first identify the mobile telephone number of the user's mobile device corresponding to the identification value (e.g., using a look-up table stored in the memory).

At step 306, the derived transaction data is sent to the identified mobile device 102 corresponding with the identification value submitted by the user. The payment processing server 118 may contact the identified mobile device using the mobile telephone number associated with the mobile device and/or a network address associated with the identified mobile device, for example, and send the derived data to the identified mobile device.

At step 308, the derived transaction data is received by the mobile device 102 for processing and, at step 310, the mobile device 102 obtains payment card information from the payment card 104 of the user and sends the payment card information to the payment processing server 118. In accordance with teachings described herein, the payment card may be required to be physically present at the mobile device 102 after the derived transaction data is received and the payment card information is obtained (a “card present” solution). In accordance with teachings herein, the payment card may be considered to be physically present if the payment card is NFC enabled and the NFC module 110 of the mobile device 102 securely captures (e.g., using NFC encryption) the payment card information from the NFC enabled payment card. In accordance with other teachings, the payment card may be considered to be physically present if the imager 108 of the mobile device captures an image of the front and/or back of the payment card and the mobile device verifies (e.g., through image analysis) that it is an image(s) of the actual payment card. The payment card information may need to be captured within a predefined period of time, e.g., within one minute, to ensure the payment card is physically present at the time of transaction processing or the payment transaction may be canceled. The predefined period of time may be adjusted based on the amount of the transaction, e.g., with larger amounts having a shortened period of time, e.g., 30 seconds.

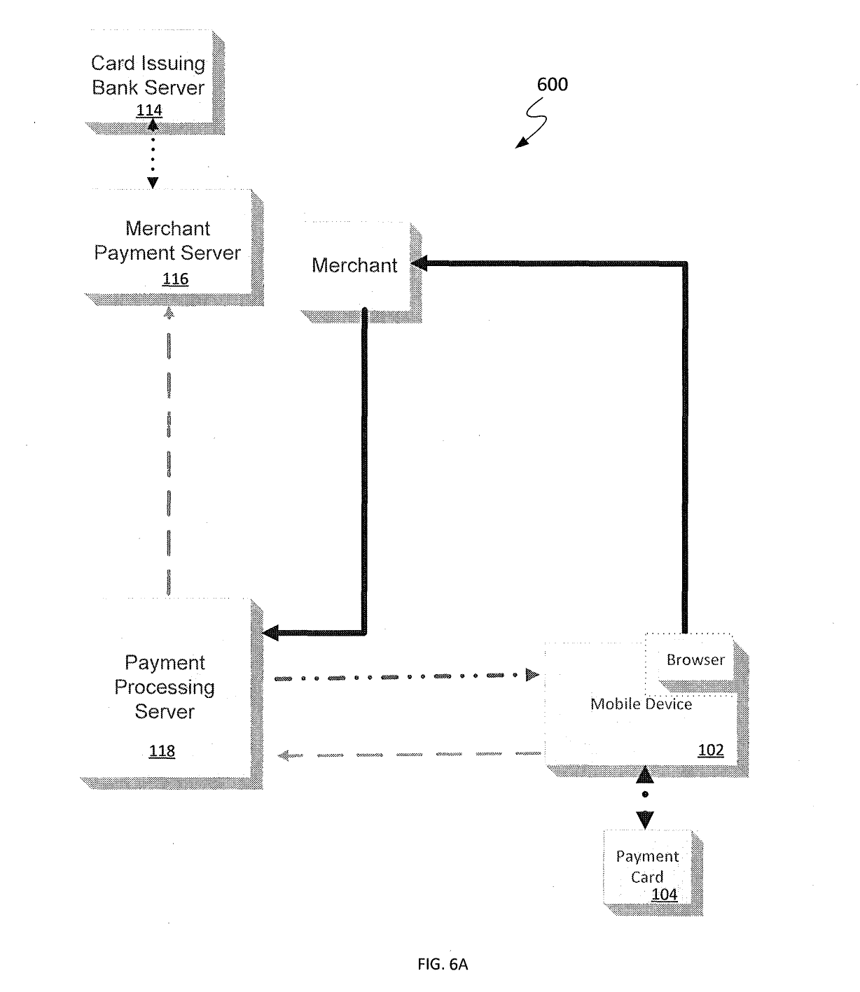

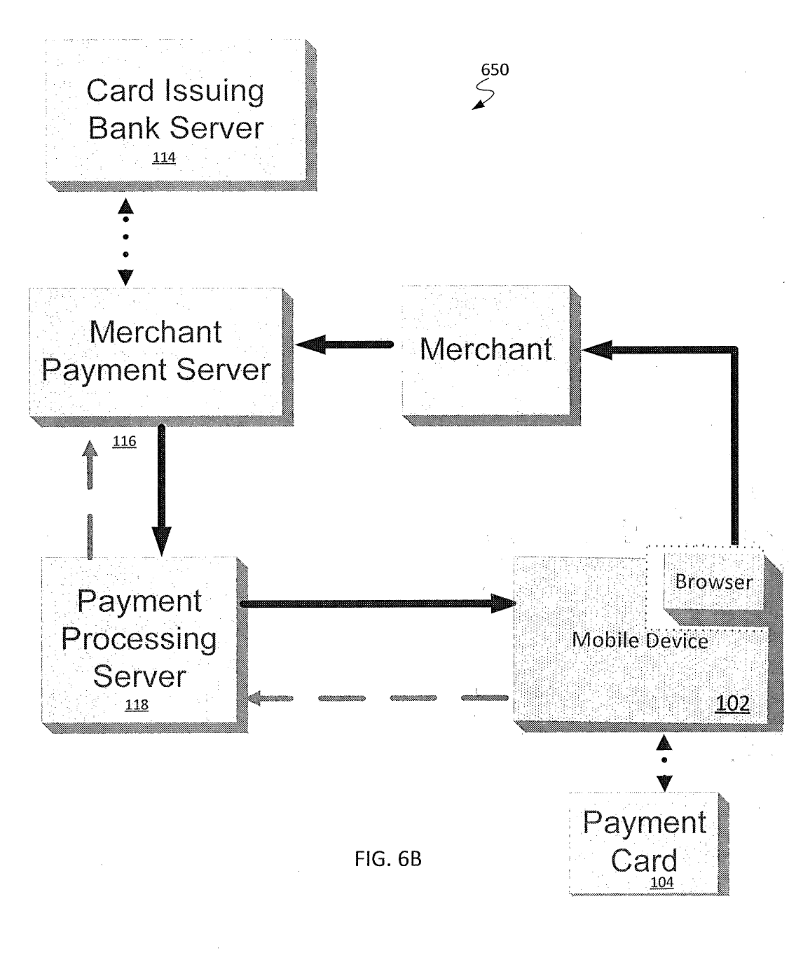

In accordance with other teachings, the payment card information may be securely stored within mobile device (e.g., an electronic wallet; a pseudo card present solution, which may be deemed a “card present” solution by a card issuing bank). The processing, obtaining, and sending by the mobile device 102 are described in further detail below with reference to FIGS. 4, 6A, and 6B.

At step 312, payment card information is received. The payment card information may be received by the payment processing server 118 from the mobile device 102. The received payment card information may have at least one layer of encryption. In accordance with teachings herein, one layer of encryption is added by the mobile device 102, e.g., to encrypt payment card information captured from a payment card with imager 108. The processor within the payment processing server 118 may be configured to decrypt at least the layer of encryption added by the mobile device 102. In accordance with other teachings herein, multiple layers of encryption may be added. For example, the payment card 104 may transmit the payment card information to the mobile device 102 via NFC with one layer of encryption (e.g., NFC encryption) added by the NFC module 112 of the payment card 104. The mobile device 102 may add an additional layer of encryption (e.g., with the secure component 200). The processor within the payment processing server 118 may be configured to decrypt at least the layer of encryption added by the mobile device 102 and the processor within the card issuing bank server may be configured to decrypt at least the layer of encryption added by the payment card.

At step 314, the payment card information is submitted for authorization. The payment processing server 118 may submit the payment card information along with the transaction information to the merchant payment server 116. The payment processing server 118 may submit the received payment card information after using its payment processing server processor to decrypt a layer of the at least one layer of encryption of the payment card information added by the mobile device.

At step 316, the purchase is authorized. The merchant payment server 116 may submit the payment card information to the card-issuing bank server 114 for authorization. The merchant payment server may use a processor (not shown) to decrypt a layer of the at least one layer of encryption added by the payment card 104. If approved, the card issuing bank server 114 notifies the merchant payment server 116 of the authorization. The authorization may then be communicated to the merchant, the payment processing server 118, and/or the mobile device 102.

FIG. 4 depicts a flow chart 400 of exemplary steps for using a mobile device to receive transaction data and send payment card information for authorizing a purchase. The steps for using the mobile device are described with reference to the payment card 104, mobile device 102, and remote system 106 described above with reference to FIGS. 1, 2A, and 3. It will be understood that other cards, apparatus, and systems may be employed to implement the steps described below.

At step 402, transaction data is received. The transaction data may be received by the mobile device 102. The transaction data may be derived by the payment processing server 118 from transaction information for the prospective purchase (e.g., the full transaction information and/or a redacted and/or a modified version thereof) and sent to the mobile device 102, where the transaction data is received. The mobile device 102 may include a cellular transceiver 109a and/or WiFi transceiver 111a configured to receive the derived transaction data and a processor 202 configured to process the received transaction data.

At step 404, approval information is presented. The approval information may be presented by the mobile device 102 to the user. The processor 202 may be configured to display information regarding the prospective purchase on display 120. The presentation of information regarding the prospective purchase may be processed under a trusted execution environment (TEE; e.g., TrustZone® by ARM Ltd. of Cambridge, UK) so that all transaction information is protected and sequestered from an unsecure operating system (e.g., Android) running on the mobile device 102.

The trusted execution environment may be used to protect and secure the presentation of approval information or information regarding the prospective purchase from, for example, any mobile device displays, any mobile device keypads, any mobile device memory, and/or any mobile device user interfaces. The trusted execution environment may increase security regarding the presentation of approval information or information regarding the prospective purchase by requiring a user to input into the mobile device one or more additional factors of identification prior to presenting approval information. One factor of identification input under the trusted execution environment into the mobile device may be a personal identification value (e.g., a personal identification number) entered on a personal identification display (e.g. a pinpad display). Another factor of identification may be a biometric identification feature. Biometric identification features may include fingerprints, retina patterns, or facial images. Biometric identification of fingerprints, facial images, and retina patterns may be performed by acquiring an image using a camera or other sensor, for example, and processing the acquired image against previously stored images using respective fingerprint, facial, and retina recognition programs.

In accordance with teachings described herein, the mobile device 102 may display the transaction information (or a derived version thereof) on the display 120 along with a query regarding the legitimacy of the prospective purchase. In accordance with these teachings the processor 202 may be configured to require user approval prior to proceeding. For example, the user may be required to select a button in touch sensors 122 of provide a biometric signature in order for the transaction to proceed. In response to the user's indication of approval, the processor 202 configures a data capture device to capture payment card information. Otherwise, the processor 202 may stop the payment transaction. If the transaction is to proceed, the processor 202 (e.g., via NFC controller 136b) displays instructions for capturing payment card information and initiates an NFC transaction (or other technique) to accept the payment card information.

In accordance with other teachings described herein, the mobile device 102 may display the transaction information (or a derived version thereof) on the display 120 along with a statement regarding an action the user must take to indicate the legitimacy of the prospective purchase. In accordance with these teachings, the processor 202 may be configured, in response to the receipt of the derived transaction data, to initiate an NFC transaction (or other technique) to accept the payment card information and display a statement on the display 120 that the user is to present a payment card if they approve the transaction. Instructions for capturing payment card information may also be displayed.

At step 406, payment card information is received. The payment card information may be received by the mobile device 102 from a payment card 104 of the user using an automated data capture device, e.g., camera 108 or NFC module 110.

In examples using an NFC module 110 as the automated capture device, the NFC module 108 is used to capture card data from an NFC enabled payment card 104 via an NFC exchange. For example, if the payment card is a credit card with card data stored in a memory 171 such as a name, credit card number, verification number, and/or security key, the NFC module 110 may interact with an NFC controller 167 in the payment card 104 to capture that information. NFC controller 136b within mobile device 102 may then process the captured information to obtain the card data (e.g., the name, credit card number, verification number and/or security key).

In examples using an imager 108 as the automated capture device, the imager 108 is used to capture an image(s) of the front and/or back of the payment card 104. For example, if the payment card is a credit card with card data printed on it such as a name and credit card number on one side and a verification number on another side, the imager 108 may capture an image of the front and/or the back of the card. Processor 202 within mobile device 102 may then process the image(s), e.g., using optical character recognition (OCR) algorithms, to obtain the card data (e.g., the name, credit card number, and/or verification number).

At step 408, the payment card information is encrypted. The payment card information may be encrypted within the secure component 200 using an encryption applet 142. Thus, an additional layer of encryption may be added in instances where the payment card information captured by the mobile device 102 has already been encrypted.

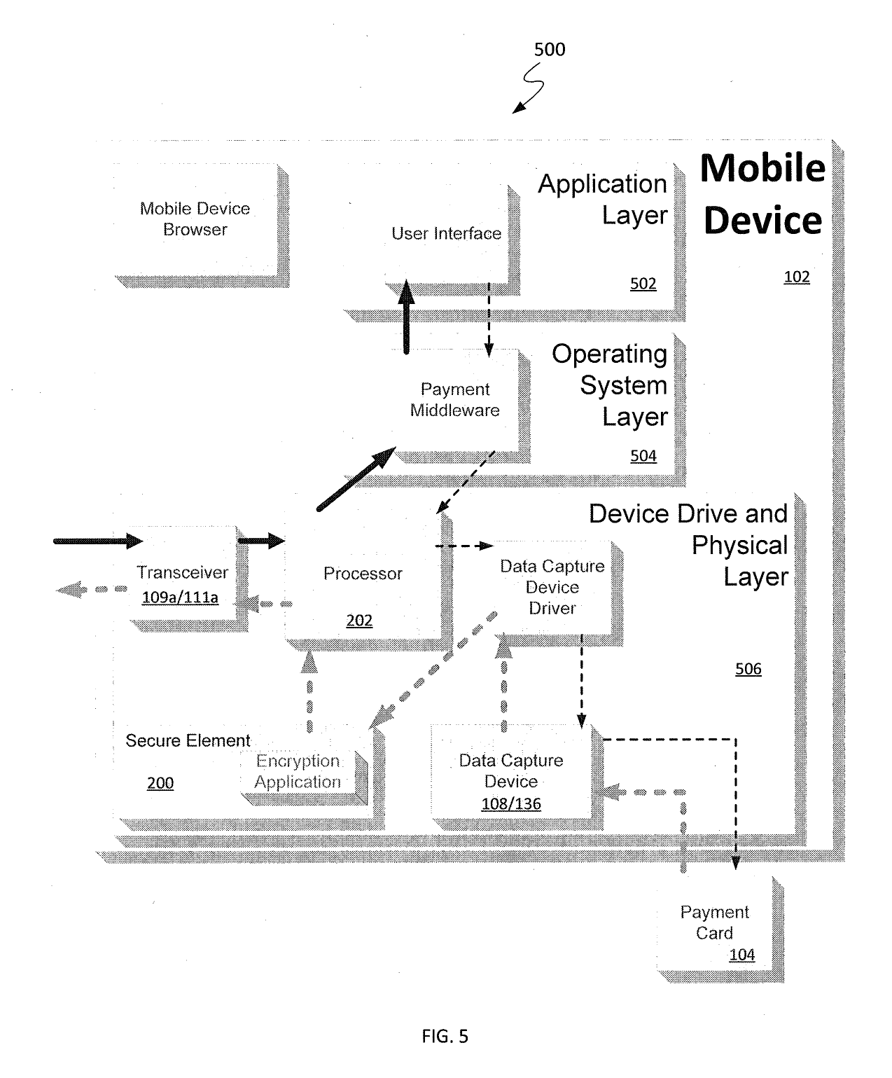

The mobile device 102 has multiple layers, including an application layer 502, an operating system layer 504, and a device drive and physical layer 506, which are described in further detail below with reference to FIG. 5. The device drive and physical layer 506 includes the data capture device(s). Any payment card information received from a data capture device passes from the data capture device through the device drives and physical layer 506 into the secure component/element 200 for encryption by an encryption application, without entering the operating system layer 504 or the application layer 502. The encrypted payment card information may also pass from the secure element through the device drives and physical layer 506 to be sent using the transceiver, without entering the operating system layer 504 or the application layer 502. Sequestering the payment card information in the device drives and physical layer 506 provides enhanced security for the payment card information.

The processor 202 may be further configured to run payment middleware in the operating system layer 504 that relays payment requests between the secure component 200 in the device drives and physical layer 506 and payment applications in the applications layer 502. The payment middleware is a middle component in the mobile devices operating system framework that communicates between payment related applications and, for example, an encryption application on the secure component 200. The payment middleware relays payment requests and payment status to mobile applications, which can accept or display payment information. The payment middleware may also keep track of different transactions and their state, making information available to the payment applications. The payment applications may include a payment application tied to a payment service such as Square (available from Square, Inc. of San Francisco, Calif.), a browser that supports a payment SDK, and/or a user interface that shows payment status for transactions initiated outside of the mobile application framework.

At step 410, the encrypted payment card information is sent. The mobile device 102 may send the encrypted payment card information to the payment processing server 118. The processor 202 of the mobile device 102 may send the encrypted payment card information using the cellular transceiver 109a or the WiFi transceiver 111a.

FIG. 5 depicts a process flow diagram for processing performed by the mobile device 102. The mobile device 102 may include a mobile device browse, e.g., for accessing the Internet. The process is described with reference to the payment card 104, mobile device 102, and server(s) 106 described above with reference to FIGS. 1, 2A, 3, and 4. It will be understood that other cards, apparatus, and systems may be employed to implement the process.

Transaction data (e.g., derived transaction data for a prospective purchase is received by the mobile device transceiver 109a/111a (e.g., from payment processing server 118). The transceiver may include an Long Term Evolution (LTE) protocol stack for transferring packets between the host device (i.e., mobile device 102) and the wireless transceiver of the host device. The protocol stack functions consist of the Medium Access Control (MAC), Radio Link Control (RLC), Packet Data Convergence Protocol (PDCP), and Radio Resource Control (RRC). The transaction data is retrieved by the processor 202, which sends the transaction data through payment middleware for viewing by a user on a user interface of the mobile device 102.

The transaction data is displayed along with a query and/or instruction for the user to indicate that the transaction is legitimate. In examples where the user is queried, a user may indicate that the transaction is legitimate via a selection made using a touch screen display 120. The selection is communicated via the payment middleware to the processor 202, which activates a data capture device driver (e.g., for the camera 108 and/or NFC module) in response to the selection. In examples where the user is instructed, the processor may activate the data capture device driver in response to receiving the transaction data. In accordance with these examples, the process flow from the user interface to the processor may be omitted.

The data capture device interfaces with the payment card 104 to retrieve payment card information. In NFC examples, the NFC module 110 sends a signal to the payment card 104 that activates the payment card. In response, the payment card provides the payment card information. In accordance with teachings herein, the payment card information may be routed directly to the secure component/element 200 without being processed by processor 202. An encryption application within the secure component/element 200 encrypts the payment card information. The encrypted payment card information is then retrieved by the processor 202 and transmitted via transceiver 109a/111a (e.g., to payment processing server 118).

FIG. 6A depicts a process flow diagram 600 for processing performed by the server(s) 106. The process is described with reference to the payment card 104, mobile device 102, and server(s) 106 described above with reference to FIGS. 1, 2A, 3, and 4. It will be understood that other cards, apparatus, and systems may be employed to implement the process.

A consumer interacts with a merchant to make a prospective purchase. The consumer may interact with the merchant via a browser located on their mobile device 102 or a browser not located on their mobile device (e.g., on another computing system). In lieu of submitting traditional payment information such as a payment card number associated with a payment card 104, the user submits an identification value (e.g., a mobile device telephone number) corresponding with the user's mobile device 102 to the merchant website. The use of an identification value corresponding to the mobile device 102 has the advantage that it is more secure because the consumer's payment card information cannot be derived from this identification value. Additionally, where the mobile device telephone number is used, it is easy for the consumer to remember and is already generally publicly available.

The merchant then transmits the identification value and transaction information to a payment processing server 118. The payment processing server 118 identifies the mobile device 102 based on the identification value. Additionally, the payment processing server derives a subset of data from the transaction information. The payment processing server then sends the derived transaction data to the identified mobile device 102, which processes the transaction data as described above with respect to FIG. 5.

If the user confirms the legitimacy of the transaction by presenting their payment card and optionally responding to a query (e.g., with a selection, personal identification number, biometric signature), the mobile device returns encrypted payment card information. The payment processing server 118 decrypts at least one layer of encryption from the payment card information (e.g., a layer of encryption added by the secure component 200 of the mobile device 102). The payment processing server 118 then sends the payment card and transaction information to the merchant payment server 116 which, in turn, interfaces with the card issuing bank server 114 to authorize the transaction. The authorization is then communicated to the payment processing server 118, the merchant, and the mobile device 102.

FIG. 6B depicts a process flow diagram 650 for processing performed by the server(s) 106. The process is described with reference to the payment card 104, mobile device 102, and server(s) 106 described above with reference to FIGS. 1, 2A, 3, and 4. It will be understood that other cards, apparatus, and systems may be employed to implement the process.

A consumer interacts with a merchant to make a prospective purchase. The consumer may interact with the merchant via a browser located on their mobile device 102 or a browser not located on their mobile device (e.g., on another computing system). As described above with respect to FIG. 6A, in lieu of submitting traditional payment information such as a payment card number associated with a payment card 104, the user submits an identification value (e.g., a mobile device telephone number) corresponding with the user's mobile device 102 to the merchant website.

The merchant then transmits the identification value and transaction information to a merchant payment server 116 of a merchant acquiring bank associated with the merchant. The merchant payment server then transmits the transaction information and the identification value to the payment processing server 118. The payment processing server 118 identifies the mobile device 102 based on the identification value. Additionally, the payment processing server derives a subset of data from the transaction information. The payment processing server then sends the derived transaction data to the identified mobile device 102, which processes the transaction data as described above with respect to FIG. 5.

If the user confirms the legitimacy of the transaction, the mobile device 102 returns encrypted payment card information. The payment processing server 118 decrypts at least one layer of encryption from the payment card information (e.g., a layer of encryption added by the secure component 200 of the mobile device 102). The payment processing server 118 then sends the payment card and transaction information to the merchant payment server 116 which, in turn, interfaces with the card issuing bank server 114 to authorize the transaction. The authorization is then communicated to the payment processing server 118, the merchant, and the mobile device 102.

The processes described above with respect to FIGS. 6A and 6B assume that the mobile device 102 is associated with the consumer. As described herein, the mobile device 102 may alternatively be associated with the merchant (e.g., using a payment application such as Square available from Square, Inc. of San Francisco, Calif.). Suitable modification of the process flows for use in such alternatives should be readily apparent from the description herein.

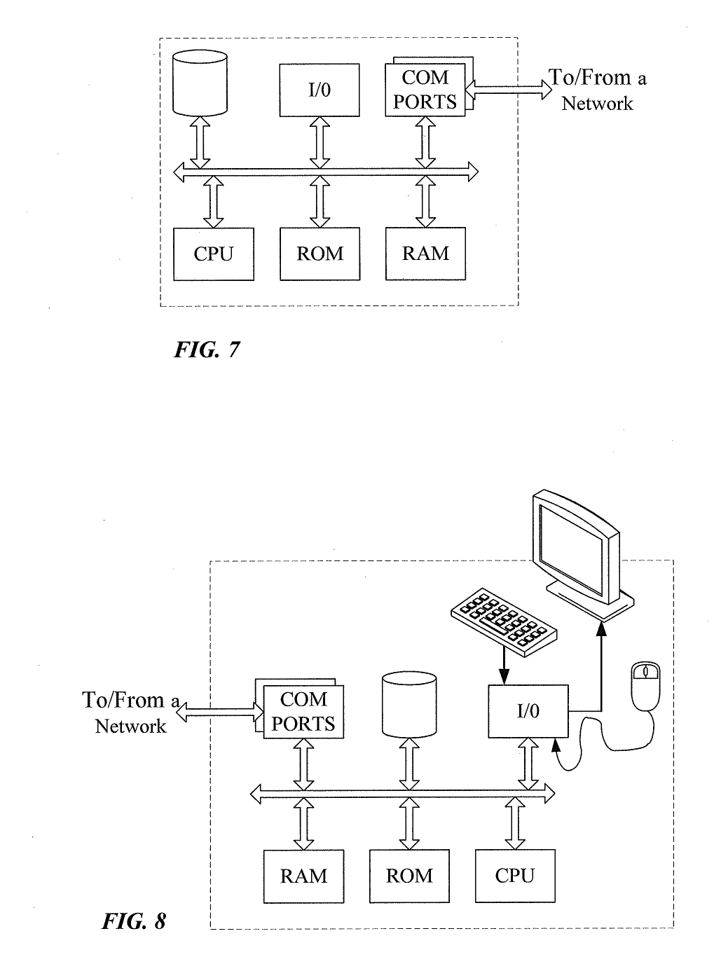

FIGS. 7 and 8 provide functional block diagram illustrations of general purpose computer hardware platforms. FIG. 7 illustrates a network or host computer platform, as may typically be used to implement a server. FIG. 8 depicts a computer with user interface elements, as may be used to implement a personal computer or other type of work station or terminal device, although the computer of FIG. 8 may also act as a server if appropriately programmed. It is believed that the structure, programming and general operation of such computer equipment and as a result the drawings should be self-explanatory.

Advantages provided by various teachings described herein described herein include improved security due to the payment card information not being accessible by the mobile device operating system (e.g., the Android operating system) and payment information not stored on server and not passed through merchants network, ease of use due to users not having to sign up for anything other than download a payment application or access a supporting website, and reduced merchant cost due to “card present” payment type.

The software functionalities described herein involve programming, including executable code as well as associated stored data, e.g. executable code and associated data files used for the applications running on the mobile device 102 for the host controller 202 and/or the NFC controller 136b. The software code is executable by the host controller 202 or the NFC controller 136b of the mobile device 102, although, at times, such software may be stored in another computer platform and downloaded through a network for installation in the mobile device 102. Execution of such code by a host controller of the mobile device 102 and/or the NFC controller 136b enables the mobile device 102 to implement the methodology for handling the various NFC communications, conducting the associated action(s) and possibly providing relevant user input/output via user interfaces, in essentially the manner performed in the implementations discussed and illustrated herein. Other executable code and associated data files may be used for the server applications running on one or more computer platforms of the server(s) 106.

Hence, aspects of the methods of card present payments and related action processing outlined above may be embodied in programming. Program aspects of the technology may be thought of as “products” or “articles of manufacture” typically in the form of executable code and/or associated data that is carried on or embodied in a type of machine readable medium.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 201, 102, or 211 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A secure payment system comprising:
a merchant payment server configured for communication with a card issuing bank; and
a payment processing server configured for communication with the merchant payment server and with a mobile device, the payment processing server configured to:
receive transaction information for a prospective purchase and an identification value corresponding to a mobile device,
derive data from the received transaction information,
identify the mobile device from the received identification value;
send, to the identified mobile device corresponding to the identification value, the derived transaction data,
after sending the derived transaction data to the identified mobile device, receive payment card information originating from the mobile device for authorizing the prospective purchase, and
submit the received payment card information to the merchant payment server for authorization by the card issuing bank.

2. The system of claim 1, wherein the merchant payment server receives the transaction information and the identification value from a merchant and the payment processing server receives the transaction information and the identification value corresponding to the mobile device from the merchant payment server.

3. The system of claim 1, wherein the payment processing server receives the transaction information and the identification value corresponding to the mobile device from a merchant and submits the received payment card information to the merchant payment server.

4. The system of claim 1, further comprising:
the mobile device, wherein the mobile device obtains the payment card information directly from a payment card present at the mobile device after the payment processing server sends the mobile device the derived transaction data.

5. The system of claim 4, wherein the payment card information is not stored on the payment processing server or the mobile device.

6. The system of claim 1, wherein the prospective purchase originates from a merchant and the payment transaction is completed without the merchant ever having possession of the payment card information.

7. A secure payment processing method comprising:
receiving, at a payment processing server, transaction information for a prospective purchase and an identification value corresponding to a mobile device;
obtaining payment card information originating from the mobile device for authorizing the prospective purchase with the payment processing server, the payment processing server including a processor configured to derive data from the received transaction information, identify the mobile device from the received identification value, send the derived transaction data to the mobile device corresponding to the identification value, and receive the payment card information originating from the mobile device for authorizing the prospective purchase after the derived transaction data is sent t the mobile device corresponding to the identification value; and
submitting, by the payment processing server, the received payment card information for authorizing the prospective purchase.

8. The method of claim 7, wherein the identification value is a mobile telephone number and wherein the mobile device is contacted using the mobile telephone number to send the derived transaction data and receive the payment card information.

9. The method of claim 7, wherein the mobile device is associated with a consumer or a merchant.

10. The method of claim 7, wherein the received payment card information from the mobile device has at least one layer of encryption and wherein the processor is further configured to decrypt a layer of the at least one layer of encryption prior to the payment processing server submitting the received payment card information.

11. The method of claim 7, wherein the payment processing server receives the transaction information and the identification value corresponding to the mobile device from a merchant payment server and submits the received payment card information to the merchant payment server.

12. The method of claim 7, wherein the payment processing server receives the transaction information and the identification value corresponding to the mobile device from a merchant and submits the received payment card information to a merchant payment server.

13. The method of claim 7, wherein the prospective purchase originates from a session between the mobile device and a merchant or a session between a computing device other than the mobile device and a merchant.

14. The system of claim 7, wherein the mobile device obtains the payment card information directly from a payment card present at the mobile device after the payment processing server sends the mobile device the derived transaction data.

15. A mobile device comprising:
a transceiver;
a secure component;
a user interface;
an automated data capture device; and
a processor configured to:
receive transaction data, derived from transaction information for a prospective purchase, from a payment processing server using the transceiver;
present the user with approval information derived from the transaction data using the user interface;
receive payment card information from a payment card of the user after presenting the approval information using the automated data capture device;
encrypt the payment card information using the secure component; and
send the encrypted payment card information to the payment processing server using the transceiver.

16. The mobile device of claim 15, wherein the automated data capture device is a near field communication module.

17. The mobile device of claim 15, wherein the secure component comprises:
a secure element; and
an encryption application running in the secure element.

18. The mobile device of claim 17, wherein the mobile device includes an application layer, an operating system layer, and a device drive and physical layer and wherein the data capture device is in the device drive and physical layer and the received payment card information passes from the data capture device through the device drives and physical layer and into the secure element for encryption by the encryption application without entering the operating system layer and the application layer.

19. The mobile device of claim 17, wherein the encrypted payment card information passes from the secure element through the device drives and physical layer to be sent using the transceiver without entering the operating system layer and the application layer.

20. The mobile device of claim 15, wherein the processor is further configured to run payment middleware that relays payment requests between the secure component and payment applications on the mobile device.

21. The mobile device of claim 15, wherein the presented approval information is a query regarding the legitimacy of the prospective purchase and the processor is configured based on a response from a user using the user interface to configure the data capture device to capture the payment card information.

22. The mobile device of claim 15, wherein the presented approval information is a statement regarding the prospective purchase and the processor is configured based on the receipt of the transaction data to configure the data capture device to capture the payment card information.

23. The mobile device of claim 15, wherein the mobile device includes a trusted execution environment that protects and secures the presentation of the approval information by the user interface.

24. The mobile device of claim 23, wherein the trusted execution environment requires a user to input at least one of a personal identification value or a biometric identification feature before the presentation of the approval information.
